(19) United States
(12) Patent Application Publication
(10) Pub. No.: US 2009/0044284 A1
(43) Pub. Date: Feb. 12, 2009

(54) System and Method of Generating and Providing a Set of Randomly Selected Substitute Characters in Place of a User Entered Key Phrase

(75) Inventor: Jothikumar GOVINDARAJU, Santa Clara, CA (US)

Correspondence Address: Greenberg Traurig, LLP (OnSpec/TPL), 2450 Colorado Avenue, Suite 400E, Santa Monica, CA, 90404, US

(73) Assignee: TECHNOLOGY PROPERTIES LIMITED, Cupertino, CA (US)

(21) Appl. No.: 11/836,757

(22) Filed: Aug. 9, 2007

(51) Int. Cl. G06F 21/00

(52) U.S. Cl. 726/30

(57) ABSTRACT

Systems and methods of generating and providing a set of randomly selected substitute characters in place of a user entered key phrase are described here. One embodiment includes receiving a key phrase input by a user to gain access to secured data, and, in response to receiving the user entered key phrase, randomly selecting a set of substitute characters and providing the set of substitute characters in place of the key phrase entered by the user. In one embodiment, the randomly selecting comprises using a random number generator to select from a substitute character from a pre-generated set of substitute characters for each character, number, or text of the user entered key phrase. In one embodiment, the providing the set of substitute characters further comprises providing the randomly selected set of substitute characters in a display buffer as the user entered key phrase.

### TECHNICAL FIELD

The present disclosure relates generally to a system and method of generating and providing a set of randomly selected substitute characters in place of a user entered key phrase.

### BACKGROUND

Data and information access is frequently authorized via passwords for identity verification. In some situations, the password entry, display and processing processes have become weak links in security implementations. For examples, passwords are increasingly used for access to personal information such as financial information, healthcare information, insurance information, emails, computing systems, etc.

There are several mechanisms under which password security could be breached thus threatening data security and personal privacy. Breach of password security may result in loss of privacy of personal information, medical information, financial loss, and identity theft. Moreover, with increased mobile access of sensitive information via wireless networks, password security can be further compromised due to the ease with which portable devices such as notebooks, portable storage devices, are lost.

For example, the brute force attack is an example of a method to obtain authentication credentials. Using brute force, attackers may attempt various combinations of the accepted character set to find a specific combination that enables access to the authorized area. Attackers can use brute force applications, such as password guessing tools and scripts. Such applications may use default password databases or dictionaries that contain commonly used passwords or they may try all combinations of the accepted character set in the password field.

Keystroke logging (e.g., key-logging) can be used as a diagnostic and debugging technique used in software development to capture keystrokes to determine sources of error in computer systems. However, the technique of keystroke logging may also be used by spy-ware and hackers.

### SUMMARY OF THE DESCRIPTION

Systems and methods of generating and providing a set of randomly selected substitute characters in place of a user entered key phrase are described here. Some embodiments of the present disclosure are summarized in this section.

One embodiment includes a method, which may be implemented on a system, of receiving a key phrase input by a user to gain access to secured data, and in response to receiving the user entered key phrase, randomly selecting a set of substitute characters and providing the set of substitute characters in place of the key phrase entered by the user. In one embodiment, the randomly selecting includes using a random number generator to select a substitute character from a pre-generated set of substitute characters for each character, number, or text of the user entered key phrase. In one embodiment, the key phrase is one of a password and a security phrase.

One embodiment further includes providing the randomly selected set of substitute characters in a display buffer in place of the user entered key phrase. One embodiment further includes storing, in a memory of a system, a representation of the user entered key phrase, the representation being different and separate from the randomly selected set of substitute characters, and comparing the representation of the user entered key phrase stored in the memory with a pre-stored value, to verify the user entered key phrase.

The present disclosure includes methods and apparatuses which perform these methods, including processing systems which perform these methods, and computer readable media which when executed on processing systems cause the systems to perform these methods.

Other features of the present disclosure will be apparent from the accompanying drawings and from the detailed description which follows.

### BRIEF DESCRIPTION OF THE DRAWINGS

The disclosure is illustrated by way of example and not limitation in the figures of the accompanying drawings in which like references indicate similar elements.

FIG. 1 is an example of a screenshot illustrating a dialog box having a password field and a security key field, according to one embodiment.

FIG. 2 is an illustration of memory locations where a user entered key phrase and a pre-stored value of the key phrase can be stored, and a display buffer location where substitute characters of the user entered key phrase can be stored, according to one embodiment.

FIG. 3 is a flow chart illustrating a process to verify a user entered key phrase, according to one embodiment.

FIG. 4 is a flow chart illustrating a process to randomly select a substitute character to be provided and displayed in place of an input character of a key phrase entered by a user, according to one embodiment.

FIG. 5 is a table illustrating an exemplary set of pre-generated substitute characters to be randomly selected in place of a user entered key phrase, according to one embodiment.

FIG. 6 illustrates an example of implementing at least one embodiment to protect user entered key phrase when attempting to access data via network connection.

FIG. 7 illustrates a block diagram of a machine-readable medium, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Embodiments of the present disclosure include systems and methods of generating and providing a set of randomly selected substitute characters in place of a user entered key phrase.

A password (e.g., key phrase, pass phrase, keyword, security code, security phrase, etc.) that has been populated into a password field can be tracked and logged by various applications. In one embodiment, a set of substitute characters is generated in place of a user entered key phase. For example, the substitute characters can be selected randomly via a random number generating algorithm (e.g., the substitute characters can be alphanumeric, numbers, text, special characters, and/or alphabets).

In one embodiment, the substitute characters are masked by miscellaneous characters to be displayed on the screen. In addition, the substitute characters may be displayed on the screen without masking. In one embodiment, the randomly selected substitute characters are stored in the display buffer in place of the key phrase as entered by the user such that applications probing the display buffer will track and log an incorrect set of characters that is different from the key phrase entered by the user.

A representation of the user entered key phrase (e.g., a hash value of the user entered key phrase) can be stored in a memory location different from that of the display buffer. Therefore, the user entered key phrase can be retained such that it can be compared with a pre-stored value of the key phrase in another location of memory to verify the user entered key phrase.

The method of generating and providing random characters in substitution of a user entered key phrase (e.g., password) can be implemented on a client device, such as a laptop computer, a handheld device, a desktop computer, and/or a cellular phone, etc. In one embodiment, the key phrase protection is applied by the client device to any application/script that prompts the user for a password. The protection can be applied to system passwords (e.g., a BIOS password, an operating system password, and/or an encryption key to decrypt encrypted data).

In one embodiment, the method of generating and providing random characters in substitution of a user entered password (or key phrase) can be implemented in applications such as an email retrieval system, an online bill pay webpage, money management software, productivity tools, etc. Further, the method of key phrase (e.g., a password, a pass phrase, etc.) protection via generating and providing random characters in substitution of the user entered password can be provided by websites where confidential information such as financial data is typically accessed via a key phrase authentication processes.

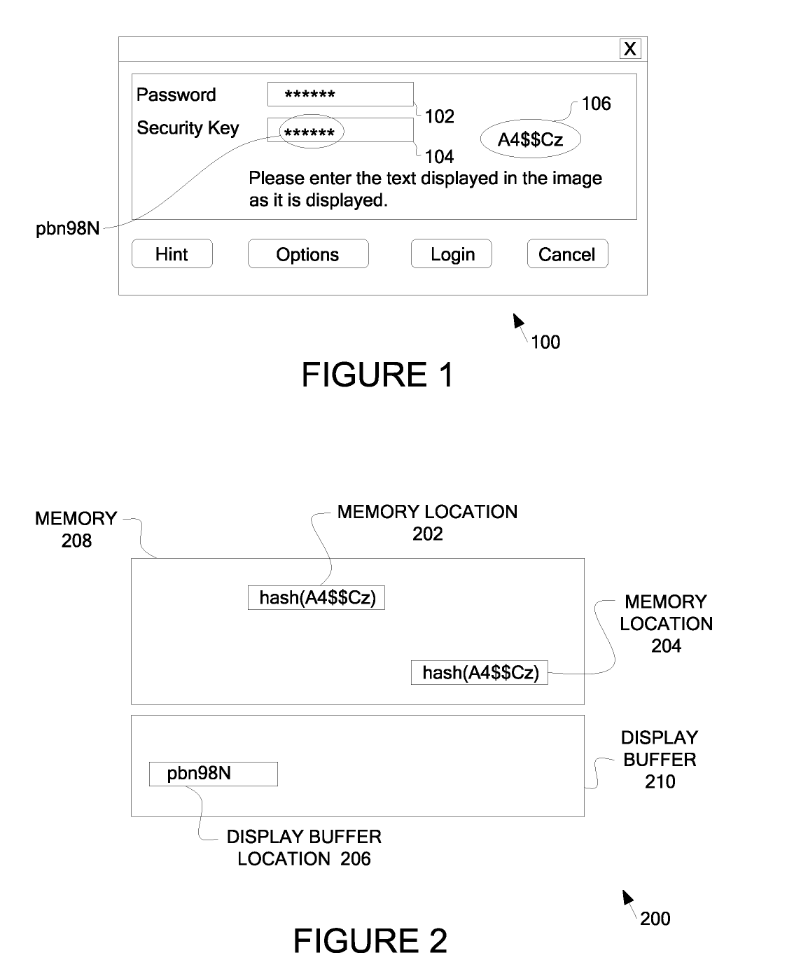

FIG. 1 is an example of a screenshot illustrating a dialog box 100 having a password field 102 and a security key field 104, according to one embodiment. Alternatively, only the password field 102, or only the security field 104 is present.

The key phrase (e.g., password) can be entered in field 102. The dialog box may also display a security phrase 106, where the characters displayed in a non-machine readable representation form (e.g., a scrambled bitmap), which are to be entered, in addition to the password, to gain access to a system or other protected data stored locally or remotely. The key phrase (password or security phrase) may be entered before logging on to a system and/or the operating system. In one embodiment, the key phrase is associated with an encryption key to encrypt data. For example, the correct key phase may be supplied prior to decrypting data that has been encrypted with the encryption key.

In some instances, the key phrase entered by a user is displayed on the screen as miscellaneous characters such as the asterisks (e.g., ‘*’), as shown in fields 102 and 104. In some instances, characters other than asterisks can be displayed on the screen.

The key phrase entered by the user is converted to a different set of characters (e.g., a set of randomly selected substitute characters) to be stored in the display buffer and to be displayed as asterisks (or other characters) on the screen, according to one embodiment. In one embodiment, the substitute characters are displayed on the screen without being masked by asterisks or other miscellaneous characters.

For example, as shown in FIG. 1, a user can enter the key phase (e.g., ‘A4$$Cz’), and in place of the security phrase entered, the set of substitute characters ‘pbn98N’, as shown in FIG. 1, is randomly selected in place of the user entered key phrase and stored in the display buffer. In one embodiment, the set of characters ‘pbn98N’ are provided to be displayed on the screen, or asterisks (or other miscellaneous characters/representations) are displayed. Thus, the characters stored in the display buffer can be the set of randomly selected substitute characters ‘pbn98N’ rather than the key phrase as entered by the user.

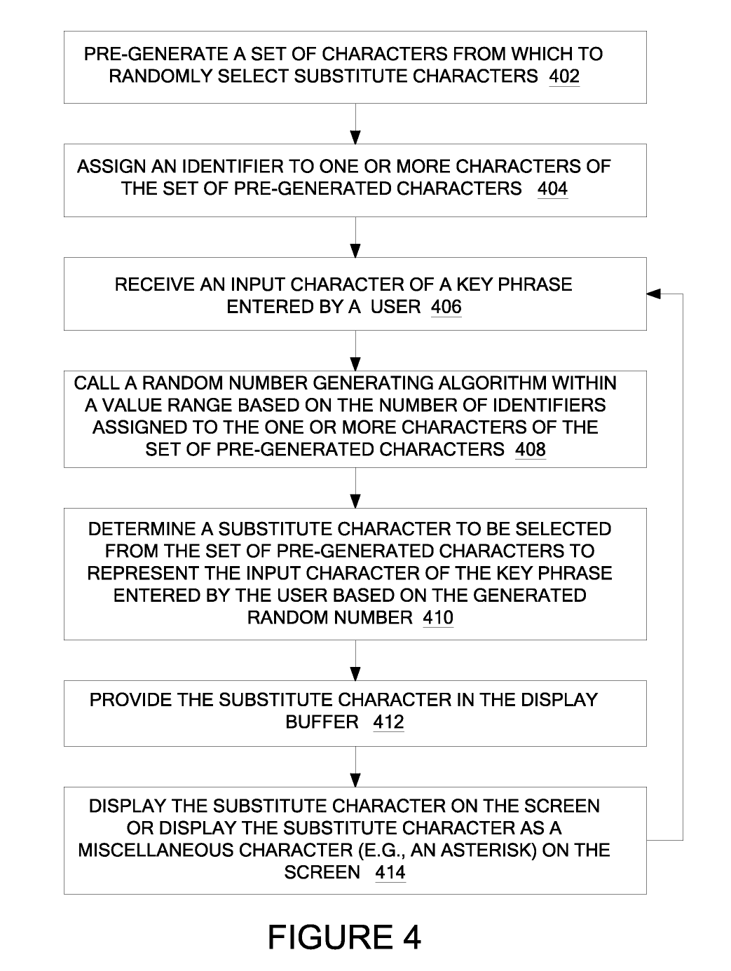

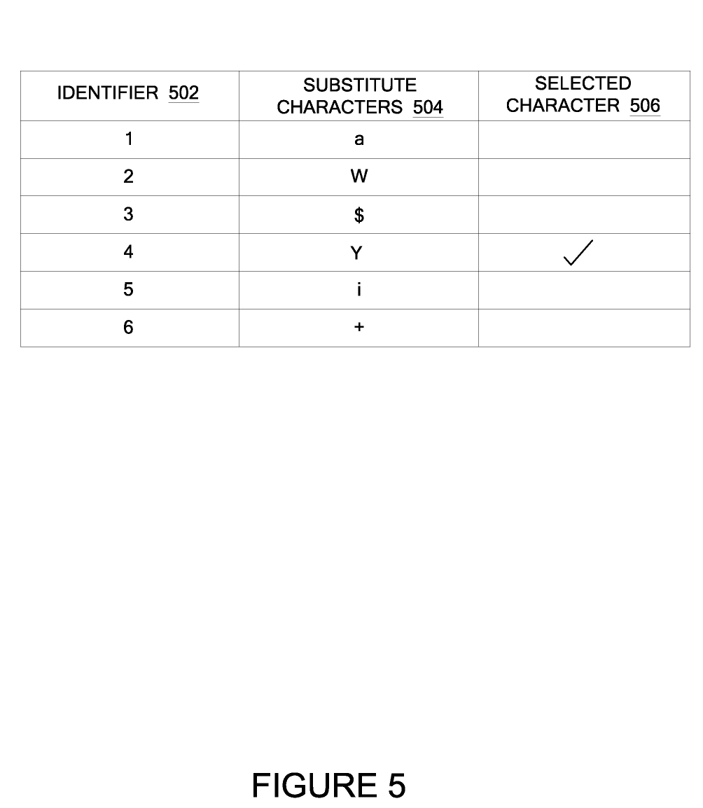

The set of substitute characters ‘pbn98N’ can be generated based on a random number generating algorithm. For example, the random number generator can be called when a character of the key phrase has been entered by a user. A substitute character can then be chosen from a pre-generated list of substitute characters based on the generated random number, as illustrated in FIGS. 4-5 to be stored in the display buffer, and, in one embodiment, displayed in place of a character of the user entered key phrase. The process can be repeated when each character of the key phrase is entered by the user.

FIG. 2 is an illustration of memory locations where a user entered key phrase and a pre-stored value of the key phrase can be stored, and a display buffer location where substitute characters of the user entered key phrase can be stored, according to one embodiment.

Once a key phrase (password) is entered by a user, a representation of the user entered key phrase (e.g., a hash value of the user entered key phrase) can be stored in memory such that the key phrase as entered by the user can be compared to a pre-stored value of the key phrase (e.g., a hash value of the key phrase) for verification purposes. Thus, in one embodiment, a hash value of the user entered key phrase, as entered, is stored in a location in memory. In addition, the user entered key phrase is converted into a randomly selected set of substitute characters which are displayed in the display buffer.

As illustrated in FIG. 2, a representation of the pre-stored value of the key phrase (e.g., a hash value of the key phrase) can be stored at another location in memory (e.g., memory location 202). Once the key phrase has been entered by the user and the hash value of the entered key phrase is stored in another memory location (e.g., memory location 204), the values in memory locations 202 and 204 can be compared to determine whether the user entered password matches the pre-stored value.

In one embodiment, the set of randomly selected substitute characters are stored in a display buffer location 206 of the display buffer 210, that is different and separate from memory locations 202 and 204 where the pre-stored value of the key phrase and the representation of user entered key phrase (e.g., a hash value of the user entered key phrase) are stored, according to one embodiment.

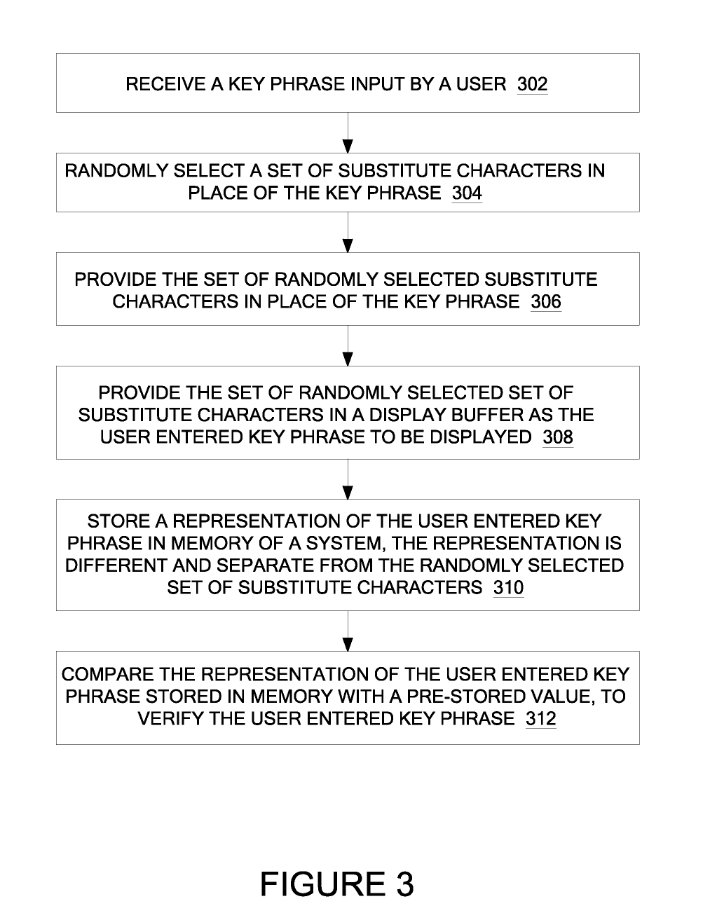

FIG. 3 is a flow chart illustrating a process to verify a user entered key phrase, according to one embodiment. In process 302, a key phrase input by a user is received. For example, the key phrase can be input by the user to access secured information from a website, on a local storage device, or any other types of services and data where the user identification is to be verified prior to grant of access. In process 304, in response to receiving the input of the key phrase, a set of substitute characters is randomly selected in place of the user entered key phrase, in one embodiment, according to the process illustrated in FIG. 4. In process 306, the set of randomly selected substitute characters are provided in place of the key phrase.

In process 308, the set of substitute characters is provided in a display buffer as the user entered key phrase to be displayed. In one embodiment, the set of substitute characters are masked with miscellaneous characters such as a string of asterisks or other characters to be displayed on the screen. In some embodiments, the set of substitute characters are displayed on the screen without masking.

In process 310, a representation of the user entered key phrase (e.g., a hash value of the user entered key phrase) is stored in memory of the system. In one embodiment, the representation of the user entered key phrase stored in the memory of the system is different and separate from the randomly selected set of substitute characters. A representation of the key phrase may be pre-stored in a separate memory location of the system from where the representation of the user entered key phrase is stored. Therefore, the representation of the user entered key phrase that is stored in the memory can be compared with a pre-stored value to verify the user entered key phrase, in process 312.

FIG. 4 is a flow chart illustrating a process to randomly select a substitute character to be provided and displayed in place of an input character of a key phrase entered by a user, according to one embodiment.

In general, a random number generating algorithm can be used to select a character to substitute a character of the user entered key phrase to be stored in the display buffer and displayed on the screen (the randomly selected substitute characters may or may not be represented as miscellaneous characters such as asterisks).

In one embodiment, each character of the user entered key phrase is substituted with a randomly selected character. The set of randomly selected substitute characters can include any combination of alpha numerals, special characters, and/or Asian characters. In addition, the substitute characters may or may not be case sensitive.

In process 402, a set of characters from which to randomly select substitute characters is pre-generated. In process 404, an identifier is assigned to one or more characters of the set of pre-generated characters. The pre-generated characters may be re-generated periodically after a pre-determined amount of time. For example, the set of pre-generated characters can be automatically updated or manually updated after the pre-determined amount of time.

In process 406, an input character of a key phrase entered by a user is received. In process 408, a random number generating algorithm is called to generate a random number within a value range. In one embodiment, the value range is based on the number of identifiers assigned to the one or more characters of the set of pre-generated characters.

In process 410, a substitute character to be selected from the set of pre-generated characters to represent the input character of the key phrase entered by the user is determined based on the generated random number. The substitute character can be selected, for example, based on the table illustrated in FIG. 5A. In process 412, the substitute character is provided in the display buffer. In process 414, the substitute character is displayed on the screen. In one embodiment, the substitute character is displayed as a miscellaneous character (e.g., an asterisk) on the screen. Processes 406 through 414 may be repeated until a substitute character has been randomly selected in place of each character of the user entered key phrase.

FIG. 5 is a table illustrating an exemplary set of pre-generated substitute characters 504 to be randomly selected in place of a user entered key phrase, according to one embodiment.

In one embodiment, the identifiers as shown in field 502 can be assigned to the pre-generated substitute characters in field 504. For example, the identifier can be a number as shown, or a combination of symbols and/or alpha-numerals. The applicable substitute characters include those shown in field 504. Other characters, such as, alpha-numerals, special characters, Asian characters, can further be included. For example, if the identifier ‘4’ is selected, the character ‘Y’ can be selected to substitute for a character in the user entered key phrase.

The identifier ‘4’ as shown in FIG. 5 can be randomly selected via one or more processes. For example, a random number can be generated via any suitable random number generating algorithm to select an identifier associated with a substitute character. In one embodiment, the range of values within with a random number is to be generated is specified based on the number of pre-generated substitute characters (e.g., the number of substitute characters in field 504). For example, if the random number ‘4’ is generated and corresponds to the identifier ‘4’ in field 502, then the substitute character ‘Y’ is selected in place of a character of the user entered key phrase.

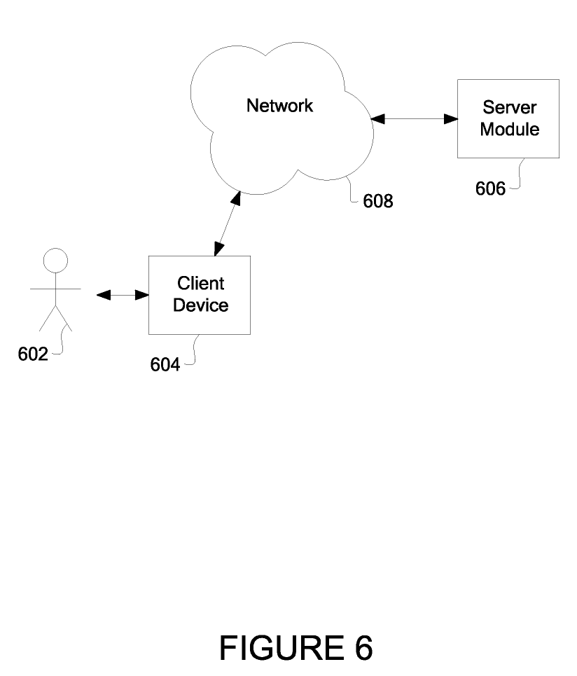

FIG. 6 illustrates an example of implementing at least one embodiment to protect user entered key phrase when attempting to access data via network connection.

As illustrated in FIG. 6, the client device 604 can be a processing device able to access remote data via a network and/or local data residing on the computing device. The client device 604 can be used to access personal financial information via a secure connection with banking or other types of financial institutes. Additionally, the client device 604 can be used to access insurance information, health information, and/or other types of data where identity authentication is performed prior to allowing access of requested data.

In one embodiment, the link to obtaining access to the protected data includes a password entry process on the client device 604. The data to be accessed can be stored locally on the client device or remotely on a device/server. The client device 604 can be any of a PDA, a laptop, a desktop computer, a telephone, a cellular phone, a portable device, and/or a server device, etc.

In one embodiment, one or more processes to provide password security via generating and providing a randomly selected set of substitute characters are provided locally (e.g., on a client device 604). Alternatively, the server module 606 can provide processes to provide password (e.g., key phrase) security. In one embodiment, the server module 606 generates and provides a randomly selected set of substitute characters in place of a user entered key phrase, suitable for accessing data locally and/or remotely.

In addition, the key phrase can also be a security key presented to the user to be entered. The key phrase, in most instances, is a code to be supplied to access protected data. In addition, the key phrase can be an encryption key to be used to decrypt data that has been encrypted by the encryption key.

The network 608, over which the client device 604, and the server module 606 communicate, may be an open network, such as the internet, or a private network, such as an intranet. In one embodiment, communications to and from the server module achieved by a secure communications protocol, such as secure sockets layer (SSL), or transport layer security (TLS).

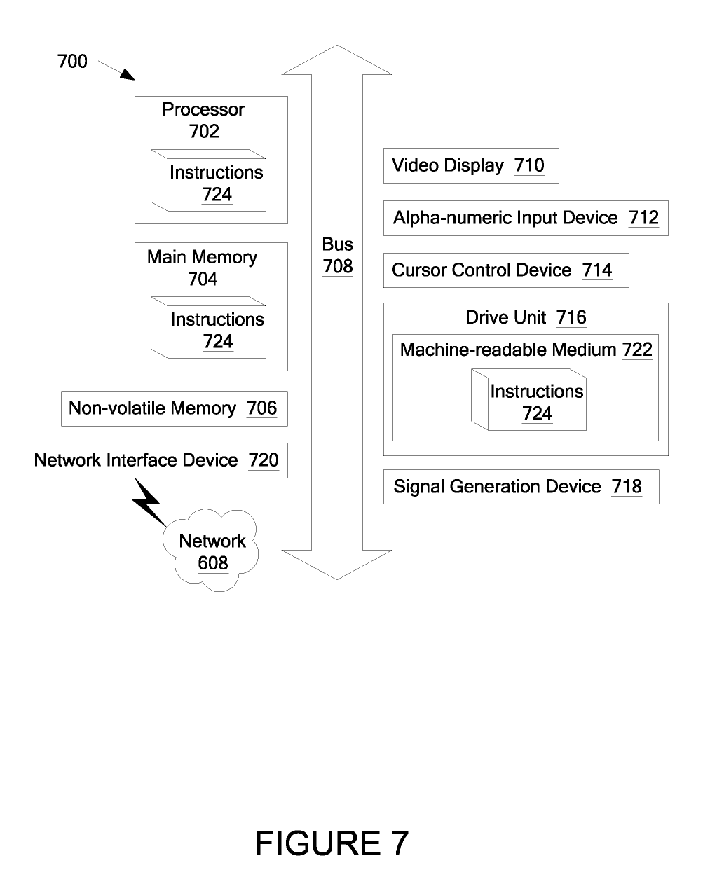

FIG. 7 shows a diagrammatic representation of a machine in the exemplary form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

While the machine-readable medium is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method comprising:
receiving a key phrase input by a user to gain access to secured data; and
in response to receiving the user entered key phrase, randomly selecting a set of substitute characters and providing the set of substitute characters in place of the key phrase entered by the user.

2. The method of claim 1, wherein the key phrase is one of a password and a security phrase.

3. The method of claim 1, wherein the randomly selecting comprises using a random number generator to select from a substitute character from a pre-generated set of substitute characters for each character, number, or text of the user entered key phrase.

4. The method of claim 1, wherein the providing the set of substitute characters further comprises providing the randomly selected set of substitute characters in a display buffer as the user entered key phrase to be displayed.

5. The method of claim 1, further comprising storing, in a memory of a system, a representation of the user entered key phrase, the representation being different and separate from the randomly selected set of substitute characters.

6. The method of claim 5, further comprising comparing the representation of the user entered key phrase stored in the memory with a pre-stored value, to verify the user entered key phrase.

7. A system, comprising:
a means for receiving a key phrase input by a user to gain access to secured data; and
a means for randomly selecting a set of substitute characters and providing the set substitute characters in place of the key phrase entered by the user, in response to receiving the user entered key phrase.

8. The system of claim 7, wherein the key phrase is one of a password and a security phrase.

9. The system of claim 7, wherein the means for randomly selecting further comprises a random number generator means for selecting a substitute character from a pre-generated set of substitute characters for each character, number, or text of the user entered key phrase.

10. The system of claim 7, wherein the means for randomly selecting and providing the set of substitute characters further comprises a means for providing the randomly selected set of substitute characters in a display buffer as the user entered key phrase to be displayed.

11. The system of claim 7, further comprising a means for storing, in a memory of a system, a representation of the user entered key phrase, the representation being different and separate from the randomly selected set of substitute characters.

12. The system of claim 11, further comprising a means for comparing the representation of the user entered key phrase stored in the memory with a pre-stored value, to verify the user entered key phrase.

13. A machine-readable medium embodying instructions, the instructions, which when executed, causing a machine to perform a method comprising:
receiving a key phrase input by a user to gain access to secured data; and
in response to receiving the user entered key phrase, randomly selecting a set of substitute characters and providing the set of substitute characters in place of the key phrase entered by the user.

14. The machine-readable medium of claim 13, wherein the key phrase is one of a password and a security phrase.

15. The machine-readable medium of claim 13, wherein the randomly selecting comprises using a random number generator to select a substitute character from a pre-generated set of substitute characters for each character, number, or text of the user entered key phrase.

16. The machine-readable medium of claim 13, wherein the providing the set of substitute characters further comprises providing the randomly selected set of substitute characters in a display buffer as the user entered key phrase to be displayed.

17. The machine-readable medium of claim 13, further comprising storing, in a memory of a system, a representation of the user entered key phrase, the representation being different and separate from the randomly selected set of substitute characters.

18. The machine-readable medium of claim 17, further comprising comparing the representation of the user entered key phrase stored in the memory with a pre-stored value, to verify the user entered key phrase.
